(19) United States
(12) Patent Application Publication
(10) Pub. No.: US 2004/0181185 A1
(43) Pub. Date: Sep. 16, 2004

(54) Device for removing diseased surface tissues

(76) Inventor: Yi-Chang Lee, Taipei (TW)

Correspondence Address: LAW OFFICE OF LIAUH & ASSOC., 4224 WAIALAE AVE, STE 5-388, HONOLULU, HI, 96816

(21) Appl. No.: 10/388,844

(22) Filed: Mar. 14, 2003

(51) Int. Cl. A61D 1/06

(52) U.S. Cl. 604/6.16; 606/137

(57) ABSTRACT

A device is designed for scraping off disordered part at the surface of soft tissues, particularly for removing diseased surface tissues deep in an ear canal. The device mainly includes a handle having a battery-powered motor mounted therein, and a scraper in the form of a hollow tube having two open ends, a front end of which is a scraper tip having a saw-toothed edge, and a rear end of which is connected to a front end of the handle and an external suction hose. When the motor is actuated, the handle and accordingly the scraper are vibrated to result in a circular motion of the scraper tip, enabling the scraper tip to scrape and exfoliate diseased tissues while the suction hose synchronously sucks effused blood and exfoliated tissues, so that the treated area is clean and easy for observation during an operation.

### BACKGROUND OF THE INVENTION

The present invention relates to a device for removing diseased surface tissues adapted to scrape off disordered part on skin or other soft tissue, particularly in an ear canal. By vibrating a scraper of the device and synchronously sucking with a suction means scraped matters from a wound undergoing treatment, the device enables highly efficient removal of diseased surface tissues and makes the wound clean and easy for observation during an operation.

When an area on human body has diseased tissues due to inflammation, suppuration, polyp, necrosis, etc., it is usually necessary to clear the diseased tissues from the area so as to provide a good re-growth environment for any wound in the area. Most existing ways of removing disordered tissues involves the use of knife, lancet, scissors, forceps, clamp, etc. An operation for removing the diseased tissues from a wound becomes particularly difficult because a surgeon performing the operation normally has to hold one of many different instruments with one hand while holding an auxiliary suction tube with another hand. Taking an operation for a hemorrhagic disorder deep in the ear canal as an example, since it is precisely performed within an extremely narrow space with the help of a microscope, the use of traditional surgical instruments would usually encounters with difficulties. Particularly, any small amount of hemorrhage at the wound would smear the doctor's visual field to largely reduce the accuracy and efficiency of the operation.

As an experienced member in the medical field, the inventor fully understands the difficulty in performing an operation in the narrow ear canal, as well as the pains and harms suffered by a patient undergoing such operation, and therefore develops a device for removing diseased surface tissues that includes a power-actuated scraper to enable a surgeon to perform a highly precise and accurate operation with reduced efforts.

### SUMMARY OF THE INVENTION

A primary object of the present invention is to provide a device for removing diseased surface tissues that combines a special scraper, suction means, and vibration generating means to enable easy and accurate scraping off of diseased surface tissues, so as to assist in doctors to solve the problem of efficient treatment of diseased surface tissues at deep and narrow areas and to alleviate the patient's pain and discomfort during the treatment.

To achieve the above and other objects, the device for removing diseased surface tissues according to the present invention mainly includes a handle and a scraper. The handle is internally provided with a motor having an eccentric wheel mounted to a rotating shaft thereof, and a battery for supplying power needed to actuate the motor. The scraper is in the form of a hollow tube having two open ends, a front end of which is a scraper tip, and a rear end of which is connected to an interconnecting section provided at a front end of the handle. A pipe is mounted in the interconnecting section with an end connected to and communicating with the open rear end of the scraper, and anther end connected to an external suction hose. When the motor is actuated, the handle and accordingly the scraper are vibrated to result in a circular motion of the scraper tip, enabling the scraper tip to scrape and exfoliate the diseased surface tissues at an area while the suction hose synchronously sucks effused blood and exfoliated tissues at the area, so that the treated area is clean and easy for observation during the treatment.

In an embodiment of the present invention, the scraper is provided at a front edge of the scraper tip with sawteeth.

In another embodiment of the present invention, the scraper is provided at one side in the vicinity of the scraper tip with an opening, so that the scraper tip is in the shape of a dipper; and an upper front edge of the opening is provided with sawteeth.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a device for removing disordered surface tissues according to a preferred embodiment of the present invention;

FIG. 2 is a sectioned side view of FIG. 1;

FIG. 3 is a fragmentary and enlarged perspective view of a scraper tip according to a first embodiment of the scraper of the device for removing disordered surface tissues according to the present invention;

FIG. 4 is a sectioned side view of FIG. 3; and

FIG. 5 is a fragmentary and enlarged side view of a scraper tip according to a second embodiment of the scraper of the device for removing diseased surface tissues according to the present invention.

### DETAILED DESCRIPTION OF THE PREFERRED EMBODIMENTS

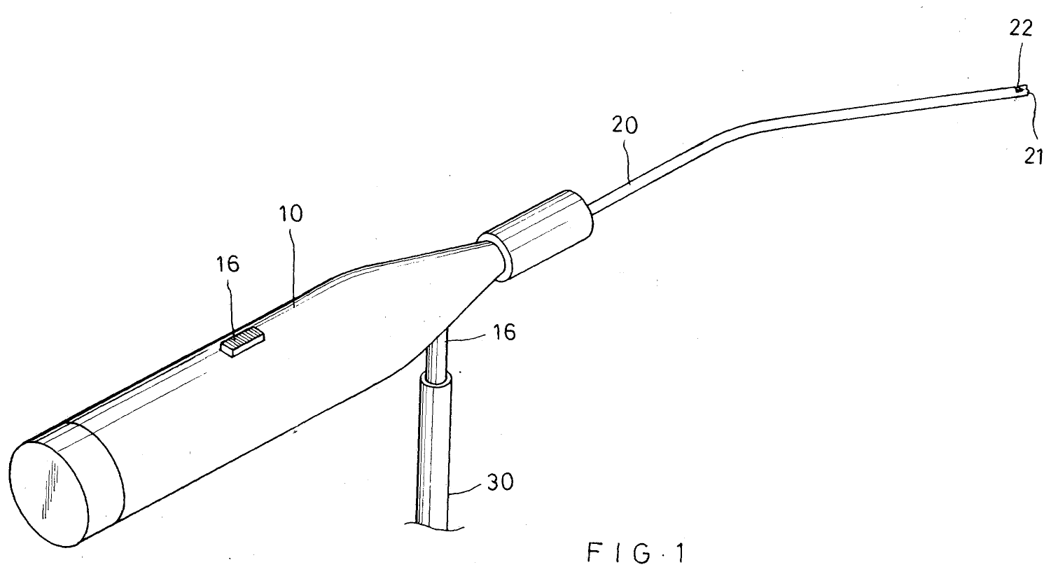

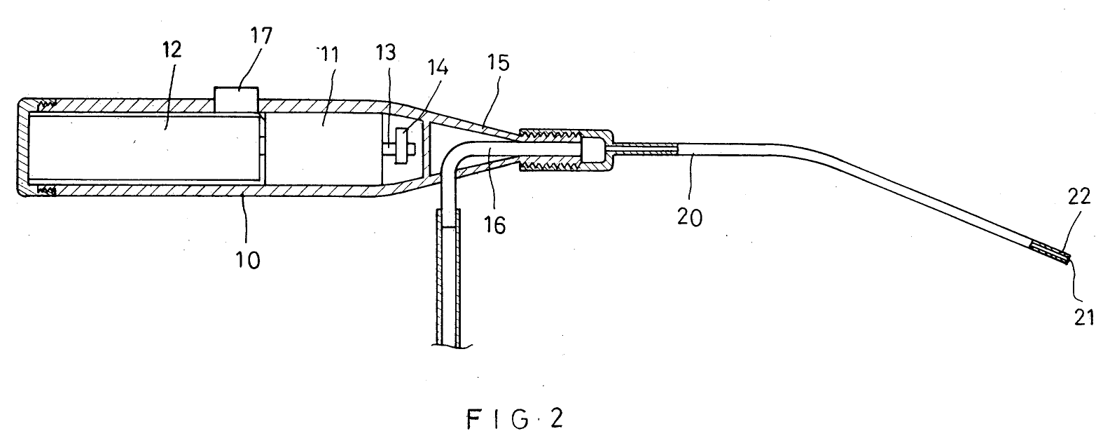

Please refer to FIGS. 1 and 2 that are perspective and sectioned side views, respectively, of a device for removing disordered surface tissues according to a preferred embodiment of the present invention. As shown, the device of the present invention mainly includes a handle 10 and a scraper 20. The handle 10 is internally provided with a motor 11 having an eccentric wheel 14 connected to a rotating shaft 13 thereof, and a battery 12 for supplying power needed to actuate the motor 11. The scraper 20 is a hollow tube having two open ends, a front end of which is a scraper tip 21, and a rear end of which is connected to an interconnecting section 15 provided at a front end of the handle 10. A pipe 16 is disposed in the interconnecting section 15 with a front end of the pipe 16 connected to and communicating with the rear open end of the scraper 20, and a rear end of the pipe 16 extended out of the interconnecting section 15 to connect to an external suction hose 30.

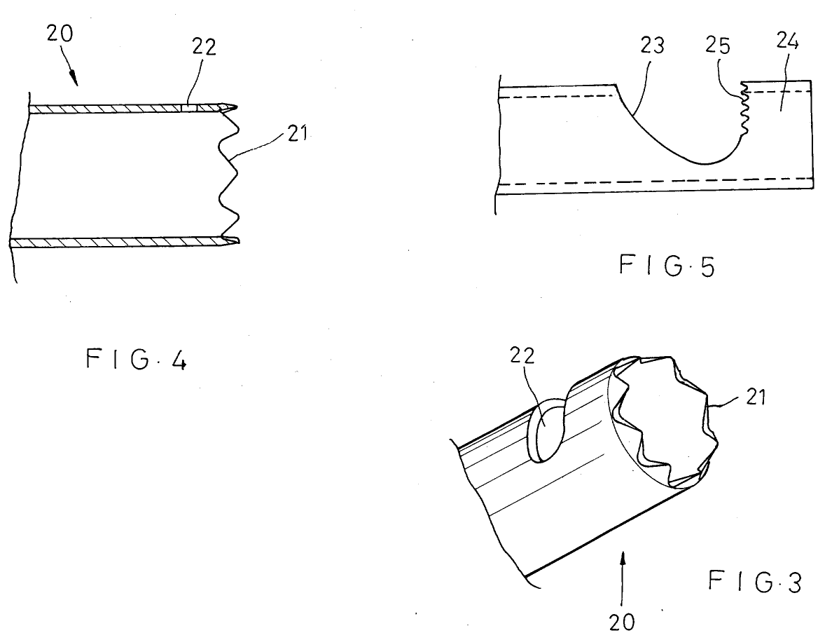

Please refer to FIGS. 3 and 4 that are fragmentary and enlarged perspective and sectioned side views, respectively, of a scrape tip 21 according to a first embodiment of the scraper 20. In this embodiment, the scrape tip 21 has a saw-toothed front edge. The number and dimensions of teeth on the saw-toothed front edge of the scrape tip 21 determine a maximum amount of disordered surface tissues that can be scraped off with the scrape tip 21 in each movement thereof. At least one small hole 22 is provided on the scraper 20 in the vicinity of the scrape tip 21 as means to balance an internal pressure of the scraper 20, lest the scraper tip 21 should suck and adhere to the disordered surface tissues and become unmoved.

When the motor 11 is actuated, it causes the handle 10 and accordingly the scraper 20 to vibrate. The vibration of the scraper 20 results in a scrape tip 21 moving in circular motion to therefore pull, cut, and exfoliate disordered tissues of a diseased area, such as gangrene, polyp, etc. The scraper tip 21 in circular motion exfoliates the diseased tissues of the gangrene, polyp, etc., a little at a time, just like nibbling something. Therefore, the scraper 20 does not forcefully pull the disordered tissues to injure surrounding normal tissues. To scrape polyp and gangrene having a larger area, a scraper 20 having a scraper tip 21 with thicker sawteeth may be used to enable removal of increased amount of disordered tissues at the beginning of a medical treatment or operation. And, a scraper 20 having a scraper tip 21 with finer sawteeth is suitable for using at a later stage during the medical treatment or operation because the finer sawteeth enable grinding-like scraping to thoroughly remove the remaining diseased tissues.

The suction hose 30 is connected to a vacuum pump (not shown) to produce suction for sucking out discharged and exfoliated matters at the diseased area. The sucked matters include effused blood, body fluid, pus, and exfoliated gangrene. The removal of such matters not only makes the diseased area clean but also enables easy observation and examination by a doctor to decide the effect of treatment or operation.

The above-described device for removing disordered surface tissues may be used in treating skin disorders and removal of maculae on skin surface. That is, the device for removing diseased surface tissues may be used to exfoliate surface tissues of skin at disordered areas, allowing new skin cells to grow within several weeks. Therefore, the device may be used to replace the expensive laser maculae removal operation.

FIG. 5 shows a scraper tip 24 according to another embodiment of the scraper 20. In this embodiment, the scraper 20 is provided at one side near a front end thereof with an opening 23, so that the scraper tip 24 of the scraper 20 is substantially in the shape of a dipper. Sawteeth 25 are provided at an upper front edge of the opening 23 on the scraper tip 24. This dipper-shaped scraper tip 24 is designed mainly for using in a tympanic inner mucous membrane layer renewal operation. When a tympanic membrane is broken to form a hole thereon and needs an ear drum repair operation (myringoplasty), the doctor may extend the dipper-shaped scraper tip 24 of the scraper 20 into the tympanum via the hole, and use the sawteeth 25 to scrape off little by little inner layer mucosa tissues from the edge of the hole, so that the free graft attached to an refreshed inner side of the ear drum and closing the perforation during subsequent growth of new tissues.

The device for removing diseased surface tissues according to the present invention may be powered with the battery 12 mounted in the handle 10, or with an external power source provided in an operation room. A current control button 17 is provided on the handle 10 to regulate the amount of supplied current to thereby adjust a vibratory force of the device.

With the above arrangements, the device for removing disordered surface tissues according to the present invention allows a doctor to manipulate it with only one hand while performing an operation. Moreover, the electrically powered device for removing disordered surface tissues enables the doctor to exfoliate the diseased tissues in an effortless manner and achieve an enhanced effect of operation while reduces pains and discomfort suffered by a patient undergoing the operation. In addition to operations for ear canal and nasal cavity, the device of the present invention may also be ideally used in treating disordered areas on skin.

What is claimed is:

1. A device for removing diseased surface tissues, comprising a handle and a scraper; said handle being internally provided with a motor having an eccentric wheel connected to a rotating shaft thereof, and a battery for supplying power needed to actuate said motor; and said scraper being a hollow tube having two open ends, a front end of which being a scraper tip, and a rear end of which being connected to an interconnecting section provided at a front end of said handle; and said interconnecting section being internally provided with a pipe, a front end of which being connected to and communicating with the rear open end of said scraper, and a rear end of said pipe being extended out of said interconnecting section to connect to an external suction hose.

2. The device for removing diseased surface tissues as claimed in claim 1, wherein said scraper has at least one small hole provided in the vicinity of said scraper tip.

3. The device for removing diseased surface tissues as claimed in claim 1, wherein said scraper tip has a saw-toothed front edge.

4. The device for removing diseased surface tissues as claimed in claim 1, wherein said scraper is provided at one side near said scraper tip with an opening, so that said scraper tip is in the shape of a dipper, and said dipper-shaped scraper tip being provided at an upper front edge of said opening with sawteeth.
